(19) United States
(12) Patent Application Publication
(10) Pub. No.: US 2022/0036231 A1
(43) Pub. Date: Feb. 3, 2022

(54) METHOD AND DEVICE FOR PROCESSING QUANTUM DATA

(71) Applicant: BEIJING BAIDU NETCOM SCIENCE TECHNOLOGY CO., LTD., Beijing (CN)

(72) Inventors: Xin WANG, Beijing (CN); Zhixin SONG, Beijing (CN); Guangxi LI, Beijing (CN)

(21) Appl. No.: 17/501,764

(22) Filed: Oct. 14, 2021

(30) Foreign Application Priority Data
Nov. 18, 2020 (CN) 202011297757.3

(51) Int. Cl. G06N 10/00; G06N 3/02; G06K 9/62

(52) U.S. Cl. CPC G06N 10/00; G06K 9/6257; G06N 3/02

(57) ABSTRACT

A method and device for processing quantum data are provided, which are related to the field of quantum computation. The method includes: determining a quantum data set and category information characterizing a data type of the quantum data set; applying a local quantum circuit to a quantum data point contained in the quantum data set, wherein the local quantum circuit is obtained after part of qubits are selected from a plurality of qubits contained in a parameterized quantum circuit; acquiring state information of qubits in the local quantum circuit after being applied to the quantum data point through measurement, and taking the state information and the category information as training data for training a classical neural network to obtain a trained classical neural network, wherein a data type of a quantum data set to be processed can be identified by the trained classical neural network.

### CROSS-REFERENCE TO RELATED APPLICATIONS

This disclosure claims priority to Chinese patent application, No. 202011297757.3, entitled “Method and Device for Processing Quantum Data”, filed with the Chinese Patent Office on Nov. 18, 2020, which is hereby incorporated by reference in its entirety.

### TECHNICAL FIELD

The present disclosure relates to the field of data processing, in particular to the field of quantum computation.

### BACKGROUND

Quantum computers are moving towards development of scale-up and practicality, and quantum machine learning is a frontier aspect in quantum computation. Similar to classical machine learning, it is very important to efficiently categorize and identify quantum data sets. Therefore, how to categorize quantum data sets becomes an urgent problem to be solved in terms of quantum machine learning.

### SUMMARY

The present disclosure provides a method and a device for processing quantum data.

According to one aspect of the present disclosure, a method for processing quantum data is provided, including:

determining a quantum data set and category information characterizing a data type of the quantum data set;

applying a local quantum circuit to a quantum data point contained in the quantum data set, wherein the local quantum circuit is obtained after part of qubits are selected from a plurality of qubits contained in a parameterized quantum circuit; and

acquiring state information of qubits in the local quantum circuit after being applied to the quantum data point through measurement, and taking the state information and the category information as training data for training a classical neural network to obtain a trained classical neural network, wherein a data type of a quantum data set to be processed can be identified by the trained classical neural network.

According to another aspect of the present disclosure, a method for processing quantum data is provided, including:

determining a quantum data set and category information characterizing a data type of the quantum data set;

applying a local quantum circuit to a quantum data point contained in the quantum data set, wherein the local quantum circuit is obtained after part of qubits are selected from a plurality of qubits contained in a parameterized quantum circuit;

acquiring state information of qubits in the local quantum circuit after being applied to the quantum data point through measurement, and taking the state information and the category information as training data for training a classical neural network; and

inputting the training data into the classical neural network to train the classical neural network and obtain a trained classical neural network, wherein a data type of a quantum data set to be processed can be identified by the trained classical neural network.

According to another aspect of the present disclosure, a quantum device is provided, including:

an information determination unit configured for determining a quantum data set and category information characterizing a data type of the quantum data set;

a circuit processing unit configured for applying a local quantum circuit to a quantum data point contained in the quantum data set, wherein the local quantum circuit is obtained after part of qubits are selected from a plurality of qubits contained in a parameterized quantum circuit;

a measurement unit configured for acquiring state information of qubits in the local quantum circuit after being applied to the quantum data point through measurement, and taking the state information and the category information as training data for training a classical neural network to obtain a trained classical neural network, wherein a data type of a quantum data set to be processed can be identified by the trained classical neural network.

According to yet another aspect of the present disclosure, a quantum device for processing quantum data is provided, including:

a quantum data processing unit configured for determining a quantum data set and category information characterizing a data type of the quantum data set; applying a local quantum circuit to a quantum data point contained in the quantum data set, wherein the local quantum circuit is obtained after part of qubits are selected from a plurality of qubits contained in a parameterized quantum circuit;

a quantum circuit measuring unit configured for acquiring state information of qubits in the local quantum circuit after being applied to the quantum data point through measurement, and taking the state information and the category information as training data for training a classical neural network;

a classical data processing unit configured for inputting the training data into the classical neural network to train the classical neural network and obtain a trained classical neural network, wherein a data type of a quantum data set to be processed can be identified by the trained classical neural network.

It is to be understood that the description in this section is not intended to identify key or critical features of the embodiments of the present disclosure, nor is it intended to limit the scope of the present disclosure. Other features of the present disclosure will become readily apparent from the following description.

### BRIEF DESCRIPTION OF THE DRAWINGS

The drawings are included to provide a better understanding of the present disclosure and are not to be construed as limiting the present disclosure, in which:

FIG. 1 is a schematic flowchart of a method for processing quantum data according to an embodiment of the present disclosure;

FIG. 2 is another schematic flowchart of a method for processing quantum data according to an embodiment of the present disclosure;

FIG. 3 is a schematic diagram of a localized parameterized quantum circuit in a particular scenario according to an embodiment of the present disclosure;

FIG. 4 is a schematic diagram of a global parameterized quantum circuit in a particular scenario according to an embodiment of the present disclosure;

FIG. 5 is a schematic diagram of implementation in a particular scenario according to an embodiment of the present disclosure;

FIG. 6 is a schematic structural diagram of a quantum device according to an embodiment of the present disclosure;

FIG. 7 is a schematic structural diagram of a quantum device for processing quantum data according to an embodiment of the present disclosure.

### DETAILED DESCRIPTION

The following describes exemplary embodiments of the present disclosure with reference to the accompanying drawings, which include various details of the embodiments of the present disclosure to facilitate understanding, and should be considered as merely exemplary. Accordingly, one of ordinary skill in the art appreciates that various changes and modifications can be made to the embodiments described herein without departing from the scope and spirit of the present disclosure. Also, descriptions of well-known functions and structures are omitted from the following description for clarity and conciseness.

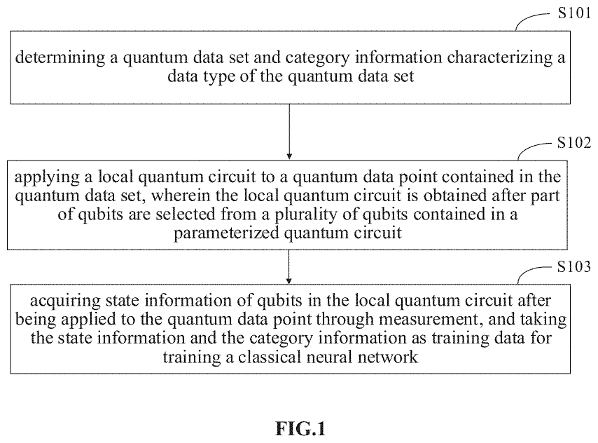

An embodiment of the present disclosure provides a method for processing quantum data, which is performed in a quantum device. Specifically, as shown in FIG. 1, the method includes:

Step S101: determining a quantum data set and category information characterizing a data type of the quantum data set.

Step S102: applying a local quantum circuit to a quantum data point contained in the quantum data set, wherein the local quantum circuit is obtained after part of qubits are selected from a plurality of qubits contained in a parameterized quantum circuit.

Step S103: acquiring state information of qubits in the local quantum circuit after being applied to the quantum data point through measurement, and taking the state information and the category information as training data for training a classical neural network to obtain a trained classical neural network, wherein a data type of a quantum data. set to be processed can be identified by the trained classical neural network.

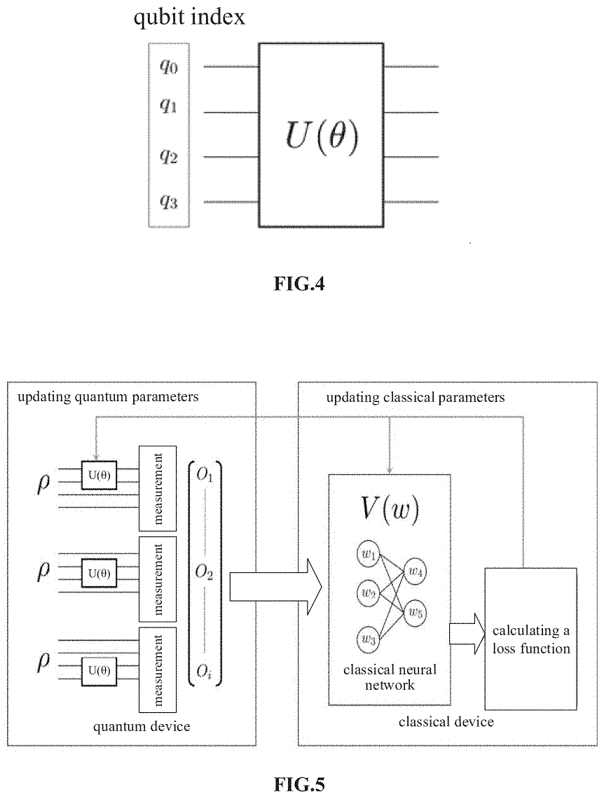

According to the solution of the present disclosure, the local quantum circuit is part of a parameterized quantum circuit, that is, a quantum circuit applying to a quantum data point (that is, a local quantum circuit) does not contain all qubits in the parameterized quantum circuit, but only contains part of qubits in the parameterized quantum circuit. As shown in FIG. 3, the parameterized quantum circuit contains four qubits. In this case, a quantum circuit containing qubits q0 and q1 may be used as the local quantum circuit in the solution of the present disclosure, and the local quantum circuit containing the qubits q₀ and q₁ is applied to an input quantum data point, while q₂ and q₃ are not contained in the local quantum circuit. In this way, compared to a global parameterized quantum circuit (as shown in FIG. 4, the global quantum circuit containing all the qubits, i.e., qubits g₀, q₁, q₂ and q₃, is applied to an input quantum data point), the number of qubits or quantum gates involved in the solution of the present disclosure can be greatly reduced, so that system noises in subsequent training processes can be greatly reduced, and a foundation is laid for improving the identification precision.

In the solution of the present disclosure, the classical neural network may be any existing neural network that can be executed in a classical computer, which is not limited herein.

Thus, by combining quantum computation and a classical neural network technology, the solution of the present disclosure lays a foundation for efficiently identifying a data type of a quantum data set.

In a specific example of the solution of the present disclosure, a local quantum circuit may be obtained in the following manner. Specifically, a parameterized quantum circuit is determined, part of qubits are selected from a plurality of qubits contained in the parameterized quantum circuit, and a quantum circuit containing the selected part of qubits is used as the local quantum circuit. In practical applications, a local quantum circuit is obtained on the basis of a parameterized quantum circuit and belongs to a part of the parameterized quantum circuit, and a plurality of pieces of state information may be obtained by adjusting selected part of qubits, so that the plurality of pieces of state information may be used as training data, a data foundation is laid for subsequent training of a classical neural network, and a foundation is further laid for efficiently identifying a data type of a quantum data set.

In a specific example of the solution of the present disclosure, the quantum device may adjust a parameter of the local quantum circuit in the following manner, so that a foundation is laid for training a classical neural network, and meanwhile, a foundation is also laid for efficiently identifying a data type of a quantum data set. Specifically, after the training data is input into the classical neural network, that is, the quantum device sends the training data to a classical device (such as a classical computer and the like), and after inputting the training data into the classical neural network through the classical device, the quantum device acquires a total degree of difference between pieces of predicted information corresponding to all quantum data points in the quantum data set and the category information, wherein the pieces of predicted information are output by the classical neural network and are used for characterizing data categories of the quantum data points, and the total degree of difference is determined based on a degree of difference between predicted information corresponding to each quantum data point in the quantum data set and the category information; and adjusts a parameter of the local quantum circuit based on the total degree of difference, to adjust the state information serving as the training data. That is to say, the quantum device can adjust the parameter of the local quantum circuit based on feedback information of the classical device so as to adjust the training data, thereby laying a foundation for subsequent training of the classical neural network and also laying a foundation for efficiently identifying a data type of a quantum data set.

In this way, by combining quantum computation with a classical neural network technology, a foundation is laid for identifying a data type of a quantum data set with high efficiency.

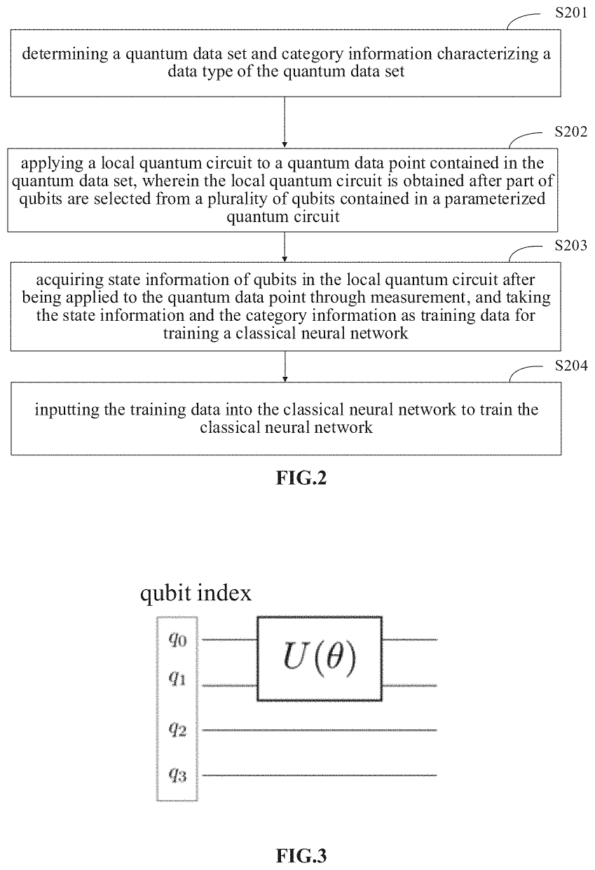

The solution of the present disclosure also provides a method for processing quantum data, specifically as shown in FIG. 2, the method includes the following steps:

Step S201: determining a quantum data set and category information characterizing a data type of the quantum data set.

Step S202: applying a local quantum circuit to a quantum data point contained in the quantum data set, wherein the local quantum circuit is obtained after part of qubits are selected from a plurality of qubits contained in a parameterized quantum circuit.

Step S203: acquiring state information of qubits in the local quantum circuit after being applied to the quantum data point through measurement, and taking the state information and the category information as training data for training a classical neural network; and

Step S204: inputting the training data into the classical neural network to train the classical neural network and obtain a trained classical neural network, wherein a data type of a quantum data set to be processed can be identified by the trained classical neural network.

Here, it should be noted that in practical applications, this example may be implemented by combining a quantum device with a classical device, e.g. steps involving quantum computation are carried out in the quantum device and steps involving classical neural network training are carried out in the classical device. Specifically, the quantum device determines a quantum data set and category information characterizing a data type of the quantum data set, and applying a local quantum circuit to a quantum data point contained in the quantum data set, wherein the local quantum circuit is obtained after part of qubits are selected from a plurality of qubits contained in a parameterized quantum circuit; and the classical device acquires state information of qubits in the local quantum circuit after being applied to the quantum data point through measurement, and takes the state information and the category information as training data for training a classical neural network, and inputs the training data into the classical neural network to train the classical neural network. In one example, the state information is measured by a measurement device, and the classical device need only acquire the state information from the measurement device.

The above step S203 may be performed in a quantum device or a classical device. For example, when the step S203 is performed in a quantum device, after acquiring the state information, the quantum device sends the state information to the classical device to prepare data for subsequent training. Alternatively, the state information is acquired directly by the classical device and used directly for subsequent training.

According to the solution of the present disclosure, the local quantum circuit is part of a parameterized quantum circuit, that is, a quantum circuit applying to a quantum data point (that is, a local quantum circuit) does not contain all qubits in the parameterized quantum circuit, but only contains part of qubits in the parameterized quantum circuit. As shown in FIG. 3, the parameterized quantum circuit contains four obits. In this case, a quantum circuit containing qubits q0 and q1 may be used as the local quantum circuit in the solution of the present disclosure, and the local quantum circuit containing the qubits g₀ and q₁ is applied to an input quantum data point, while g₂ and q₃ are not contained in the local quantum circuit. In this way, compared to a global parameterized quantum circuit (as shown in FIG. 4, the global quantum circuit containing all the qubits, i.e., qubits g₀, q₁, q₂ and q₃, is applied to an input quantum data point), the number of qubits or quantum gates involved in the solution of the present disclosure can be greatly reduced, so that system noises in subsequent training processes can be greatly reduced, and a foundation is laid for improving the identification precision.

In the solution of the present disclosure, the classical neural network may be any existing neural network that can be executed in a classical computer, which is not limited herein.

Therefore, the solution of the present disclosure can solve the problem of categorizing a quantum data set by combining quantum computation with a classical neural network technology, namely, a classical neural network of which training is completed can be used for identifying a data type of a quantum data set to be processed to obtain a categorization result, so that categorization with high efficiency and high accuracy is realized.

In a specific example of the solution of the present disclosure, a local quantum circuit may be obtained in the following manner. Specifically, a parameterized quantum circuit is determined, part of qubits are selected from a plurality of qubits contained in the parameterized quantum circuit, and a quantum circuit containing the selected part of qubits is used as the local quantum circuit. In practical applications, a local quantum circuit is obtained on the basis of a parameterized quantum circuit and belongs to a part of the parameterized quantum circuit, and a plurality of pieces of state information may be obtained by adjusting selected part of qubits, so that the plurality of pieces of state information may be used as training data, a data foundation is laid for subsequent training of a classical neural network, and a foundation is further laid for efficiently identifying a data type of a quantum data set.

In a specific example of the solution of the present disclosure, after the state information is input into the classical neural network, predicted information characterizing a data category of the quantum data point is output, and pieces of predicted information corresponding to all quantum data points in the quantum data set is obtained. In practical applications, after state information corresponding to each quantum data point contained in the quantum data set is input into the classical neural network according to the implementation of the solution of the present disclosure, the pieces of predicted information corresponding to all the quantum data points in the quantum data set can be obtained. Further, the classical device obtains a total degree of difference based on a degree of difference between predicted information corresponding to each quantum data point and the category information, determines a loss function based on the total degree of difference, and the classical device adjusts a parameter of the classical neural network based on the loss function. The quantum device adjusts a parameter of the local quantum circuit based on the loss function, and further adjusts state information serving as training data so as to complete training of the classical neural network. That is, both the quantum device and the classical device can adjust the parameter of the local quantum circuit and the parameter of the classical neural network correspondingly based on the feedback information of the classical device so as to complete the training process, thereby laying a foundation for efficiently identifying a data type of a quantum data set.

In a specific example of the solution of the present disclosure, the degree of difference may also be obtained by calculating a cross entropy between predicted information corresponding to a quantum data point and the category information, and the calculated cross entropy is taken as the degree of difference between the predicted information corresponding to the quantum data point and the category information. For example, the classical device calculates a cross entropy between predicted information corresponding to a quantum data point and the category information, takes the calculated cross entropy as the degree of difference between the predicted information corresponding to the quantum data point and the category information, and further obtains a loss function based on the cross entropy. Thereby, a foundation is laid for efficient training, further a foundation is laid for identifying a data type of a quantum data set with high efficiency.

In a specific example of the solution of the present disclosure, after the training of the classical neural network is completed and the parameter adjustment based on the local quantum circuit is completed, the classical neural network and the local quantum circuit may be used for categorizing a quantum data set of unknown data type. Specifically, a quantum data set to be processed is acquired; a local quantum circuit in which parameter adjustment is completed is applied to the quantum data set to be processed; state information of qubits in the local quantum circuit after being applied to a quantum data point in the quantum data set to be processed is acquired through measurement; and the state information of qubits in the local quantum circuit is input into the classical neural network of which training is completed to obtain predicted information characterizing a data type of the quantum data set to be processed. For example, a quantum device acquires a quantum data set to be processed and applies a local quantum circuit in which parameter adjustment is completed to a quantum data point of the quantum data set to be processed, and a measuring device measures state information of qubits in the local quantum circuit after being applied to the quantum data point in the quantum data set to be processed, and the classical device acquires the state information and input the state information of qubits of the local quantum circuit into the classical neural network of which training is completed to obtain predicted information characterizing a data type of the quantum data set to be processed, so that the data type of the quantum data set can be identified with high efficiency.

In practical applications, only predicted information obtained for one quantum data point in a quantum data set may be used as a categorization result of the quantum data set, or the categorization result of the quantum data set may be determined based on pieces of predicted information corresponding to all quantum data points in the quantum data set, which is not limited herein. Here, on the basis that the accuracy of the prediction result of the classical neural network reaches a certain extent, only one piece of predicted information obtained for one quantum data point can be used as the categorization result of the quantum data set.

It is to be noted that in practical applications, adjusting a parameter of a local quantum circuit may be specifically adjusting qubits selected from a parameterized quantum circuit, so as to adjust a rotation angle and the like corresponding to the local quantum circuit to finally select a designated qubit from the parameterized quantum circuit, wherein the designated qubit may correspond to one qubit or a plurality of qubits in the parameterized quantum circuit, but only corresponding to part of instead of all the qubits in the parameterized quantum circuit.

Therefore, the solution of the present disclosure can combine quantum computation with a classical neural network technology to solve the problem of categorization of a quantum data set, namely, a classical neural network of which training is completed can be used for identifying a data type of a quantum data set to be processed to obtain a categorization result, so that categorization with high efficiency and high accuracy is realized.

The solution of the present disclosure is described in further detail below with reference to a specific example. Specifically, the example utilizes a localized parameterized quantum circuit (i.e., a local quantum circuit only applied to selected qubits in the quantum circuit) that can be provided by a quantum device, and combines with the data processing capability of a classical neural network to perform post-processing on intermediate information output by a measurement quantum system, thereby optimizing a categorization result of categorizing a quantum data set. Here, the structure of the localized parameterized quantum circuit used in the present example may be designed in advance in accordance with limitations of a quantum hardware device, more adapted to recent quantum devices. Compared with an existing common global quantum circuit, the number of qubits or quantum gates involved in the example is greatly reduced, and system noise in a training process is further reduced. At the same time, this example can also easily cope with a multi-categorization problem of categorizing a plurality of quantum data sets.

In addition, the present example also sets an activation function similar to that in a classical neural network, such as Softmax function, and takes a cross entropy between a true label (i.e., true category information of the quantum data set) and a predicted label for the quantum data set output by the classical neural network as a loss function, and parameters in the localized parameterized quantum circuit and/or the classical neural network are optimized based on the loss function, so that the accuracy of the categorization result is improved.

It is to be noted that the localized parameterized quantum circuit refers to a part of qubits in the parameterized quantum circuit. As shown in FIG. 3, the parameterized quantum circuit contains four qubits. At this time, a quantum circuit containing cubits q₀ and q₁ may be used as a local quantum circuit in the solution of the present disclosure, and the local quantum circuit containing the qubits q₀ and q₁ is applied to an input quantum data point, wherein q₂ and q₃ are not contained in the local quantum circuit. Accordingly, the global parameterized quantum circuit includes all the qubits in the parameterized quantum circuit. As shown in FIG. 4, the parameterized quantum circuit includes four obits. At this time, a global quantum circuit including all the qubits, i.e., qubits q, q₁, q₂, and q₃, is applied to the input quantum data point.

The following is described prior to the description of detailed steps of the exemplary solution. Specifically, a quantum data set S={ρ^{(m)}, y^{(m)}}ₘ₌₁^{N} containing N elements is given in which ρ^{(m)} represents a m-th element (i.e. a m-th quantum data point) in the quantum data set encoded into quantum state, and a corresponding label is y^{(m)}, and the y^{(m)} may be characterized by a vector, such as a x-dimensional vector. If the quantum data set belongs to a first category, only the first element in the m-dimensional vector is 1, the rest are all 0; if the quantum data set belongs to a second category, only the second element in the m-dimensional vector is 1, the rest are all 0, and so on, and the category information of the quantum data set is thus represented.

In practical applications, the quantum state ρ of n qubits may be represented as a Hermitian matrix of 2ⁿ×2ⁿ, and tr (ρ)=1, wherein tr refers to the trace of the matrix. In this case, the quantum state may be characterized by a positive semi-definite matrix.

As shown in FIG. 5, the specific implementation is as follows.

Step 1: a parameterized quantum circuit with adjustable parameters is prepared, for example, the parameterized quantum circuit includes a plurality of single qubit rotating gates, controlled reverse gates and the like, wherein a plurality of rotating angles in the parameterized quantum circuit form a vector θ which is a parameter of the parameterized quantum circuit. At this time, a localized parameterized quantum circuit, i.e., a local quantum circuit, may be denoted as U(θ).

Step 2: a classical neural network is prepared, including a plurality of weight coefficients (also referred to as parameters), which constitute a vector w, i.e. a parameter of the classical neural network, on this basis, the classical neural network is denoted as V(w).

Step 3: the localized parameterized quantum circuit U(θ) prepared in step 1. is applied to an input quantum data point ρ^{(m)}, and state information of the localized parameterized quantum circuit U(θ) after being applied to the quantum data point ρ^{(m)} is measured by a measuring system. Specifically, as shown in FIG. 4, the state information corresponding to θ in the U(θ) after being applied to the quantum data point ρ^{(m)} is denoted as Oᵢ. In practical applications, different state information may be obtained by adjusting the applied vector θ, for example, O₁, O₂, Oᵢ and the like may be obtained. At this time, the obtained different state information may be grouped into a vector, which is denoted as O.

Here, i is generally an empirical value, which may be determined based on the actual scenario or the qubit set actually required to be processed, which is not limited herein.

Step 4: the state information O obtained in step 3 is input into the classical neural network V(w) to obtain an output result y̅^{(m)} which is a prediction label of the quantum data point ρ^{(m)}.

Step 5: a cross entropy L^{(m)}=Σⱼ₌₁^{k}yⱼ^{(m)}log(y̅ⱼ^{(m)}) is calculated, wherein j represents a j-th category and there are k categories.

Step 6: each quantum data point in the quantum data set S is continuously input, the steps 3-5 are repeated, and L^{(m)} is summed to obtain a final loss function L.

Step 7: based on a gradient descent method or other optimization methods, the loss function L is minimized by adjusting the parameter of the classical neural network V(w) and the parameter ∝ in the parameterized quantum circuit U(θ), optimal parameters are obtained and denoted as θ* and w*, and the output result y̅^{(m)} is approximate to a real label y^{(m)} under the optimal parameters θ* and w*.

Step 8: the optimized local quantum circuit U(θ*) and the neural network V(w*) are applied to other quantum data sets to be categorized to obtain the category information of the quantum data sets.

Here, it is to be noted that, in practical applications, processes involving quantum data are carried out on a quantum device, while processes involving a classical neural network are carried out on a classical device, such as a classical computer, such that a data type of a quantum data set can be identified with high efficiency by combining quantum computation with a classical neural network technique.

It is worth mentioning that, based on a categorizer obtained in the above manner, the accuracy of a categorization task of identifying a handwritten number can reach more than 99.5%,

According to the solution of the present disclosure, a parameterized quantum circuit provided by a recent quantum device can be fully utilized, the capability of efficiently extracting characteristics of quantum data of a localized parameterized quantum circuit and the data processing capability of a classical neural network are combined to deal with the identification problem of a quantum data set. In addition, based on a loss function designed to be capable of performing calculation with high efficiency on a recent quantum device, the categorization with high efficiency and high accuracy is realized. In addition, since the parameters of the local quantum circuit utilized in the solution of the present disclosure can be few, less noise may be introduced when performing categorization processing, and a foundation is laid fir improving the accuracy of a categorization result.

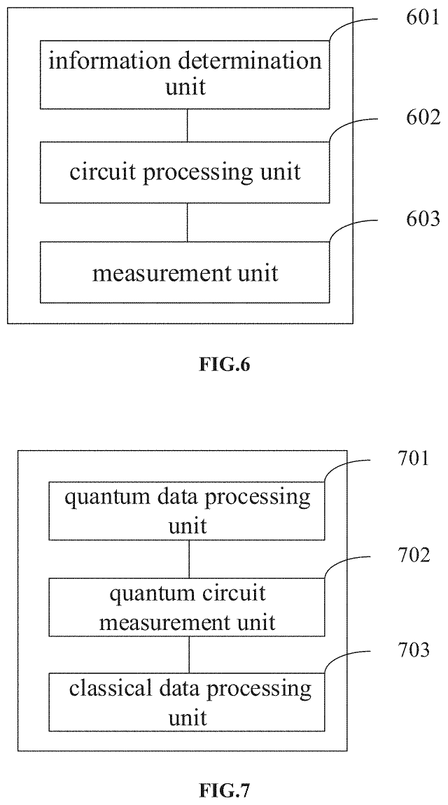

The solution of the present disclosure provides a quantum device, as shown n FIG. 6, including:

an information determination unit 601 configured for determining a. quantum data set and category information characterizing a data type of the quantum data set;

a circuit processing unit 602 configured for applying a local quantum circuit to a quantum data point contained in the quantum data set, wherein the local quantum circuit is obtained after part of qubits are selected from a plurality of qubits contained in a parameterized quantum circuit;

a measurement unit 603 configured for acquiring state information of qubits in the local quantum circuit after being applied to the quantum data point through measurement, and taking the state information and the category information as training data for training a classical neural network to obtain a trained classical neural network, wherein a data type of a quantum data set to be processed can be identified by the trained classical neural network.

In a specific example of the solution of the present disclosure, further includes:

a selecting unit configured for determining the parameterized quantum circuit, selecting part of qubits from the plurality of qubits contained in the parameterized quantum circuit, and taking a quantum circuit containing the selected part of qubits as the local quantum circuit, wherein a plurality of pieces of state information can be obtained by adjusting the selected part of qubits.

In a specific example of the solution of the present disclosure, further includes:

a degree of difference acquiring unit configured for acquiring a total degree of difference between pieces of predicted information corresponding to all quantum data points in the quantum data set and the category information, wherein the pieces of predicted information are output by the classical neural network and are used for characterizing data categories of the quantum data points; the total degree of difference is determined based on a degree of difference between predicted information corresponding to each quantum data point in the quantum data set and the category information; and

a parameter adjusting unit configured for adjusting a parameter of the local quantum circuit based on the total degree of difference, to adjust the state information serving as the training data.

The solution of the present disclosure also provides a quantum device for processing quantum data, which is shown in FIG. 7, including:

a quantum data processing unit 701 configured for determining a quantum data set and category information characterizing a data type of the quantum data set; applying a local quantum circuit to a quantum data point contained in the quantum data set, wherein the local quantum circuit is obtained after part of qubits are selected from a plurality of qubits contained in a parameterized quantum circuit;

a quantum circuit measuring unit 702 configured for acquiring state information of qubits in the local quantum circuit after being applied to the quantum data point through measurement, and taking the state information and the category information as training data for training a classical neural network;

a classical data processing unit 703 configured for inputting the training data into the classical neural network to train the classical neural network and obtain a trained classical neural network, wherein a data type of a quantum data set to be processed can be identified by the trained classical neural network.

In a specific example of the solution of the present disclosure, the quantum data processing unit 701 is further configured for determining the parameterized quantum circuit, selecting part of qubits from the plurality of qubits contained in the parameterized quantum circuit, and taking a quantum circuit containing the selected part of qubits as the local quantum circuit, wherein a plurality of pieces of state information can be obtained by adjusting the selected part of qubits.

In a specific example of the solution of the present disclosure, the classical data processing unit 703 is further configured for outputting predicted information characterizing a data category of the quantum data point, to obtain pieces of predicted information corresponding to all quantum data points in the quantum data set, after the training data is input into the classical neural network; obtaining a total degree of difference based on a degree of difference between predicted information corresponding to each quantum data point and the category information; determining a loss function based on the total degree of difference; and adjusting a parameter of the classical neural network based on the loss function to complete training of the classical neural network.

The quantum data processing unit is further configured for adjusting a. parameter of the local quantum circuit based on the loss function to complete training of the classical neural network.

In a specific example of the solution of the present disclosure, the classical data processing unit 703 is further configured for calculating a cross entropy between the predicted information corresponding to the quantum data point and the category information, and taking the calculated cross entropy as the degree of difference between the predicted information corresponding to the quantum data point and the category information.

In a specific example of the solution of the present disclosure, the quantum data processing unit 701 is further configured for acquiring a quantum data set to be processed; and applying the local quantum circuit of which a parameter is adjusted to the quantum data set to be processed.

The quantum circuit measuring unit 702 is further configured for acquiring state information of qubits in the local quantum circuit after being applied to a quantum data point in the quantum data set to be processed through measurement.

The classical data processing unit 703 is further configured for inputting the state information of the qubits in the local quantum circuit into the trained classical neural network, to obtain predicted information characterizing a data type of the quantum data set to be processed.

It should be noted that in practice, the quantum data processing unit 701 may be a quantum device, the quantum circuit measurement unit 702 may be embodied as a measurement device, and the classical data processing unit 703 may be embodied as a classical device, such as a classical computer or the like.

The solution of the embodiments of the present disclosure can combine quantum computation with a classical neural network technology to solve the problem of categorization of a quantum data set, namely, a classical neural network of which training is completed can be used for identifying a data type of a quantum data set to be processed to obtain a categorization result, so that categorization with high efficiency and high accuracy is realized.

It should be understood that the steps in the various processes described above may be reordered or omitted, or other steps may be added therein. For example, the steps described in the present disclosure may be performed in parallel or sequentially or may be performed in a different order, so long as the desired result of the technical solutions disclosed in the present disclosure can be achieved, and no limitation is made herein.

Above specific embodiments do not constitute a limitation on the protection scope of the present disclosure. It should be understood by those skilled in the art that various modifications, combinations, sub-combinations, and substitutions may be available according to design requirements and other factors. Any modifications, equivalent replacements and improvements made within the spirit and principle of the present disclosure shall be covered within the protection scope of the present disclosure.

What is claimed is:

1. A method for processing quantum data, comprising:
determining a quantum data set and category information characterizing a data type of the quantum data set;
applying a local quantum circuit to a quantum data point contained in the quantum data set, wherein the local quantum circuit is obtained after part of qubits are selected from a plurality of qubits contained in a parameterized quantum circuit; and
acquiring state information of qubits in the local quantum circuit after being applied to the quantum data point through measurement, and taking the state information and the category information as training data for training a classical neural network to obtain a trained classical neural network, wherein a data type of a quantum data set to be processed can be identified by the trained classical neural network.

2. The method of claim 1, further comprising:
determining the parameterized quantum circuit, selecting part of qubits from the plurality of qubits contained in the parameterized quantum circuit, and taking a quantum circuit containing the selected part of qubits as the local quantum circuit, wherein a plurality of pieces of state information can be obtained by adjusting the selected part of qubits.

3. The method of claim 1, further comprising:
acquiring a total degree of difference between pieces of predicted information corresponding to all quantum data points in the quantum data set and the category information, wherein the pieces of predicted information are output by the classical neural network and are used for characterizing data categories of the quantum data points; the total degree of difference is determined based on a degree of difference between predicted information corresponding to each quantum data point in the quantum data set and the category information; and
adjusting a parameter of the local quantum circuit based on the total degree of difference, to adjust the state information serving as the training data.

4. The method of claim 2, further comprising:
acquiring a total degree of difference between pieces of predicted information corresponding to all quantum data points in the quantum data set and the category information, wherein the pieces of predicted information are output by the classical neural network and are used for characterizing data categories of the quantum data points; the total degree of difference is determined based on a degree of difference between predicted information corresponding to each quantum data point in the quantum data set and the category information; and
adjusting a parameter of the local quantum circuit based on the total degree of difference, to adjust the state information serving as the training data.

5. A method for processing quantum data, comprising:
determining a quantum data set and category information characterizing a data type of the quantum data set;
applying a local quantum circuit to a quantum data point contained in the quantum data set, wherein the local quantum circuit is obtained after part of qubits are selected from a plurality of qubits contained in a parameterized quantum circuit;
acquiring state information of qubits in the local quantum circuit after being applied to the quantum data point through measurement, and taking the state information and the category information as training data for training a classical neural network; and
inputting the training data into the classical neural network to train the classical neural network and obtain a trained classical neural network, wherein a data type of a quantum data set to be processed can be identified by the trained classical neural network.

6. The method of claim 5, further comprising:
determining the parameterized quantum circuit, selecting part of qubits from the plurality of qubits contained in the parameterized quantum circuit, and taking a quantum circuit containing the selected part of qubits as the local quantum circuit, wherein a plurality of pieces of state information can be obtained by adjusting the selected part of qubits.

7. The method of claim 5, further comprising:
outputting predicted information characterizing a data category of the quantum data point, to obtain pieces of predicted information corresponding to all quantum data points in the quantum data set, after the training data is input into the classical neural network;
obtaining a total degree of difference based on a degree of difference between predicted information corresponding to each quantum data point and the category information; and
determining a loss function based on the total degree of difference, adjusting a parameter of the classical neural network and a parameter of the local quantum circuit based on the loss function to complete training of the classical neural network.

8. The method of claim 6, further comprising:
outputting predicted information characterizing a data category of the quantum data point, to obtain pieces of predicted information corresponding to all quantum data points in the quantum data set, after the training data is input into the classical neural network;
obtaining a total degree of difference based on a degree of difference between predicted information corresponding to each quantum data point and the category information; and
determining a loss function based on the total degree of difference, adjusting a parameter of the classical neural network and a parameter of the local quantum circuit based on the loss function to complete training of the classical neural network.

9. The method of claim 7, further comprising:
calculating a cross entropy between the predicted information corresponding to the quantum data point and the category information, and taking the calculated cross entropy as the degree of difference between the predicted information corresponding to the quantum data point and the category information.

10. The method of claim 5, further comprising:
acquiring a quantum data set to be processed;
applying the local quantum circuit of which a parameter is adjusted to the quantum data set to be processed;
acquiring state information of qubits in the local quantum circuit after being applied to a quantum data point in the quantum data set to be processed through measurement; and
inputting the state information of the qubits in the local quantum circuit into the trained classical neural network, to obtain predicted information characterizing a data type of the quantum data set to be processed.

11. A quantum device, comprising:
an information determination unit configured for determining a quantum data set and category information characterizing a data type of the quantum data set;
a circuit processing unit configured for applying a local quantum circuit to a quantum data point contained in the quantum data set, wherein the local quantum circuit is obtained after part of qubits are selected from a plurality of qubits contained in a parameterized quantum circuit; and
a measurement unit configured for acquiring state information of qubits in the local quantum circuit after being applied to the quantum data point through measurement, and taking the state information and the category information as training data for training a classical neural network to obtain a trained classical neural network, wherein a data type of a quantum data set to be processed can be identified by the trained classical neural network.

12. The quantum device of claim 11, further comprising:
a selecting unit configured for determining the parameterized quantum circuit, selecting part of qubits from the plurality of qubits contained in the parameterized quantum circuit, and taking a quantum circuit containing the selected part of qubits as the local quantum circuit, wherein a plurality of pieces of state information can be obtained by adjusting the selected part of qubits.

13. The quantum device of claim 11, further comprising:
a degree of difference acquiring unit configured for acquiring a total degree of difference between pieces of predicted information corresponding to all quantum data points in the quantum data set and the category information, wherein the pieces of predicted information are output by the classical neural network and are used for characterizing data categories of the quantum data points; the total degree of difference is determined based on a degree of difference between predicted information corresponding to each quantum data point in the quantum data set and the category information; and
a parameter adjusting unit configured for adjusting a parameter of the local quantum circuit based on the total degree of difference, to adjust the state information serving as the training data.

14. The quantum device of claim 12, further comprising:
a degree of difference acquiring unit configured for acquiring a total degree of difference between pieces of predicted information corresponding to all quantum data points in the quantum data set and the category information, wherein the pieces of predicted information are output by the classical neural network and are used for characterizing data categories of the quantum data points; the total degree of difference is determined based on a degree of difference between predicted information corresponding to each quantum data point in the quantum data set and the category information; and
a parameter adjusting unit configured for adjusting a parameter of the local quantum circuit based on the total degree of difference, to adjust the state information serving as the training data.

15. A quantum device for processing quantum data, comprising:
a quantum data processing unit configured for determining a quantum data set and category information characterizing a data type of the quantum data set; applying a local quantum circuit to a quantum data point contained in the quantum data set, wherein the local quantum circuit is obtained after part of qubits are selected from a plurality of qubits contained in a parameterized quantum circuit;
a quantum circuit measuring unit configured for acquiring state information of qubits in the local quantum circuit after being applied to the quantum data point through measurement, and taking the state information and the category information as training data for training a classical neural network; and
a classical data processing unit configured for inputting the training data into the classical neural network to train the classical neural network and obtain a trained classical neural network, wherein a data type of a quantum data set to be processed can be identified by the trained classical neural network.

16. The quantum device of claim 15, wherein
the quantum data processing unit is further configured for determining the parameterized quantum circuit, selecting part of qubits from the plurality of qubits contained in the parameterized quantum circuit, and taking a quantum circuit containing the selected part of qubits as the local quantum circuit, wherein a plurality of pieces of state information can be obtained by adjusting the selected part of qubits.

17. The quantum device of claim 15, wherein
the classical data processing unit is further configured for outputting predicted information characterizing a data category of the quantum data point, to obtain pieces of predicted information corresponding to all quantum data points in the quantum data set, after the training data is input into the classical neural network; obtaining a total degree of difference based on a degree of difference between predicted information corresponding to each quantum data point and the category information; determining a loss function based on the total degree of difference; and adjusting a parameter of the classical neural network based on the loss function to complete training of the classical neural network; and
the quantum data processing unit is further configured for adjusting a parameter of the local quantum circuit based on the loss function to complete training of the classical neural network.

18. The quantum device of claim 16, wherein
the classical data processing unit is further configured for outputting predicted information characterizing a data category of the quantum data point, to obtain pieces of predicted information corresponding to all quantum data points in the quantum data set, after the training data is input into the classical neural network; obtaining a total degree of difference based on a degree of difference between predicted information corresponding to each quantum data point and the category information; determining a loss function based on the total degree of difference; and adjusting a parameter of the classical neural network based on the loss function to complete training of the classical neural network; and
the quantum data processing unit is further configured for adjusting a parameter of the local quantum circuit based on the loss function to complete training of the classical neural network.

19. The quantum device of claim 17, wherein the classical data processing unit is further configured for calculating a cross entropy between the predicted information corresponding to the quantum data point and the category information, and taking the calculated cross entropy as the degree of difference between the predicted information corresponding to the quantum data point and the category information.

20. The quantum device of claim 17, wherein
the quantum data processing unit is further configured for acquiring a quantum data set to be processed; and applying the local quantum circuit of which a parameter is adjusted to the quantum data set to be processed;
the quantum circuit measuring unit is further configured for acquiring state information of qubits in the local quantum circuit after being applied to a quantum data point in the quantum data set to be processed through measurement; and
the classical data processing unit is further configured for inputting the state information of the qubits in the local quantum circuit into the trained classical neural network, to obtain predicted information characterizing a data type of the quantum data set to be processed.
